(19) United States
(12) Patent Application Publication
(10) Pub. No.: US 2014/0025734 A1
(43) Pub. Date: Jan. 23, 2014

(54) Dynamic Community Generation Based Upon Determined Trends Within a Social Software Environment

(71) Applicant: Keith Griffin, Galway (IE)

(72) Inventor: Keith Griffin, Galway (IE)

(73) Assignee: CISCO TECHNOLOGY, INC., San Jose, CA (US)

(21) Appl. No.: 13/551,928

(22) Filed: Jul. 18, 2012

(51) Int. Cl. G06F 15/16

(52) U.S. Cl. 709/204

(57) ABSTRACT

Techniques are provided for automatic identification of a trending topic within a social software enterprise platform. The trending topic comprises a topic that includes content relating to a threshold amount of activities associated with participants of the platform. A trending topic community within the platform is automatically generated in response to the trending topic meeting a threshold criteria, and participants identified as being associated with the trending topic are automatically invited to join as members of the trending topic community.

### TECHNICAL FIELD

The present disclosure relates to enterprise social software environments and the formation of communities within such environments.

### BACKGROUND

Enterprise social software environments or platforms can exist in many different commercial, business and social settings to enhance interaction between participants of such environments. For example, one form of an enterprise social software environment or platform comprises a unified electronic or enterprise collaboration platform (e.g., Cisco Quad, WebEx Connect, Microsoft SharePoint, etc.), which includes multiple forms of communication between participants (e.g., email, instant messaging, file synchronization, wikis, audio/video/web conferencing, desktop sharing, etc.) within a single platform. An enterprise collaboration platform can enhance productivity in the workplace or commercial environment by providing a mechanism for participants or users to engage in multiple forms of communication with many people that are related to topics of interest for each participant, where the participants may be local (e.g., within the same corporate offices) or remote from each other (e.g., located at many different geographic locations). Other examples of social software platforms include social networking services or platforms that provide and enhance social relations between participants within such platforms.

Communities can also be formed within many enterprise social software platforms, where a community comprises a collection or group of participants within an environment who join together based upon one or more common interests or goals. In addition, communities typically include information related to the group of participants, such as documents, blogs, wikis, etc. that are associated with the group of participants and are relevant to a particular community. Typically, an enterprise social software platform provides a mechanism for allowing a participant to create a community within the platform and request other participants to join such community. Other participants of the platform may also discover the community (e.g., while operating within the platform) and request to become a member of such community, where such participants may be admitted or denied access/membership in the community based upon present member criteria and/or acceptance.

In addition, a tool that has recently developed within enterprise social platforms is referred to as “trending”. Trending refers to a mechanism in which the platform can identify crowd sourced topics (trending topics), in which the platform can determine a topic that is popular or of elevated interest at any given time (e.g., based upon usage of a topic, the frequency by which the topic is followed by participants, etc.). Trending can also refer to popular participants of the platform (e.g., based upon the number of other participants following a particular participant). While trending is utilized, e.g., in certain social networks or platforms (e.g., the utilization of hashtags in Twitter) to identify general groups or topics within the platform, there is no present mechanism in an enterprise social platform for utilizing trending in any other manner that may bring participants together within a social environment or platform.

### BRIEF DESCRIPTION OF THE DRAWINGS

FIG. 1 is a schematic block diagram of an example system in which computing devices are connected to facilitate operation within an enterprise social software platform in which computing devices communicate with each other.

FIG. 2 is a schematic block diagram of an example computing device connected with a server that facilitates operations of an enterprise social software platform within the system of FIG. 1.

FIG. 3 is a schematic block diagram of an enterprise collaboration application module utilized for the computing device depicted in FIG. 2.

FIG. 4 is a schematic block diagram of an enterprise collaboration application module utilized for the server depicted in FIG. 2.

FIGS. 5 and 6 depict an example embodiment of a graphical user interface for a participant within an enterprise collaboration platform utilizing the system of FIG. 1.

FIG. 7 is a flow chart depicting an example process for dynamically establishing trending communities within an enterprise social software platform utilizing the techniques described herein.

FIG. 8 is an example embodiment of an automatically generated message within an enterprise collaboration platform utilizing the system of FIG. 1 and the process depicted in the flow chart of FIG. 7.

FIG. 9 depicts an example embodiment of a graphical user interface of a user engaged within a community within an enterprise social software platform utilizing the techniques described herein.

### DESCRIPTION OF EXAMPLE EMBODIMENTS

### Overview

Techniques are provided for automatic identification of a trending topic within a social software enterprise platform. The trending topic comprises a topic that includes content relating to a threshold amount of activities associated with participants of the platform. A trending topic community within the platform is automatically generated in response to the trending topic meeting a threshold criteria, and participants identified as being associated with the trending topic are automatically invited to join as members of the trending topic community.

### EXAMPLE EMBODIMENTS

Enterprise social software environments or platforms are described herein that facilitate the dynamic generation of communities within such platforms based upon identified trends within the platforms. As previously noted, an enterprise social software platform can comprise an enterprise collaboration platform, in which a plurality of software tools or software application modules and related services are spread among computing devices and also link the computing devices within the platform to allow users to work together utilizing a number of different types of communication tools and also in one or more particular settings (e.g., within an enterprise such as a company or organization, or in a collaborative effort between two or more enterprises) in an effort to achieve common business goals and strategies. The term “tool” is used herein to refer to an “application” software function or set of functions provided by a software application on a computing device and/or hosted on a server on behalf of a computing device. Application modules refer to a set of one or more software applications that provide the software tools used by the computing devices and/or servers. Some elements or features of a collaboration platform can include messaging (e.g., email, calendaring and scheduling, contact lists, etc.), team collaboration features (e.g., synchronization of documents or files common to a particular community or group associated with the files, including posted or edited web logs or blogs, wikis, other forms of written ideas and/or notes, etc.), and real time or near real time communications (e.g., instant messaging, short messaging service or SMS, web conferencing, white boarding, screen content or desktop sharing, voice, audio and/or video conferencing, etc.). An enterprise collaboration platform is particularly useful for large companies, organizations or other entities in that it is designed to facilitate high usage volume between many users (e.g., hundreds or thousands of employees in one or more companies, organizations or groups) as well as multiple simultaneous sessions with different groups or communities of users utilizing the platform. Some examples of enterprise collaboration platforms which provide multiple types of communication mediums for participants include, without limitation, Cisco Quad (Cisco Systems, Inc.), WebEx Connect (Cisco Systems, Inc.), Microsoft SharePoint (Microsoft Corporation) and LotusLive (IBM Corporation).

Enterprise social software platforms can also include social networking platforms that can generate and enhance social relationships between participants operating within the platforms. Some examples of social software platforms include, without limitation, Facebook, MySpace, Twitter, Yammer, Jive and Google+.

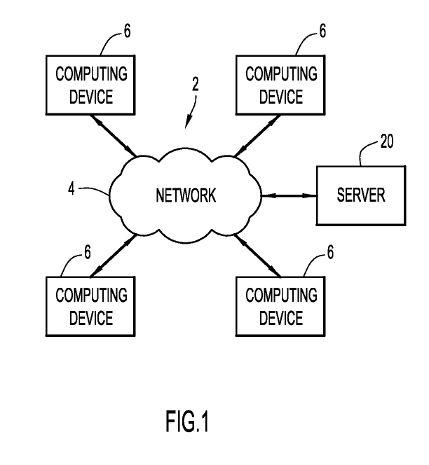

Referring to FIG. 1, a block diagram is shown for an example system that supports operation of an enterprise social software platform in which a plurality of computing devices communicate and exchange information with each other via one or more servers which host the platform. In particular, the system 2 comprises a network 4 that facilitates communications and exchange of information between a plurality of computing devices 6 as well as one or more platform servers 20. Examples of types of networks that can be utilized within system 2 include, without limitation, any one or more of local or wide area networks, Internet Protocol (IP) networks such as intranet or internet networks, telephone networks (e.g., public switched telephone networks), wireless or mobile phone or cellular networks, and any suitable combinations thereof.

It is noted that four computing devices 6 are shown for example purposes only. In a collaboration platform, such as an enterprise collaboration platform, the number of computing devices can be any suitable number (e.g., hundreds, thousands or more computing devices).

The system 2 also includes at least one host server 20 to host the operations of the platform so as to facilitate communications and exchange of information and content between the computing devices 6. While a single platform server 20 is depicted in FIG. 1, it is noted that the system 2 can include any number of servers and/or other computing devices to host or support operations and functions of the platform in a suitable manner and depending upon the number of computing devices/participants within the platform. Alternatively, it is noted that the platform can also be supported in any other suitable manner, in which one or more computing devices are configured to facilitate a suitable connection with other computing devices over the network 4 to provide communications and exchange of information associated with the collaboration platform. The collaboration platform is spread across a number of servers/computing devices, with each computing device including one or more software modules including one or more applications that facilitate operation of each computing device within the platform.

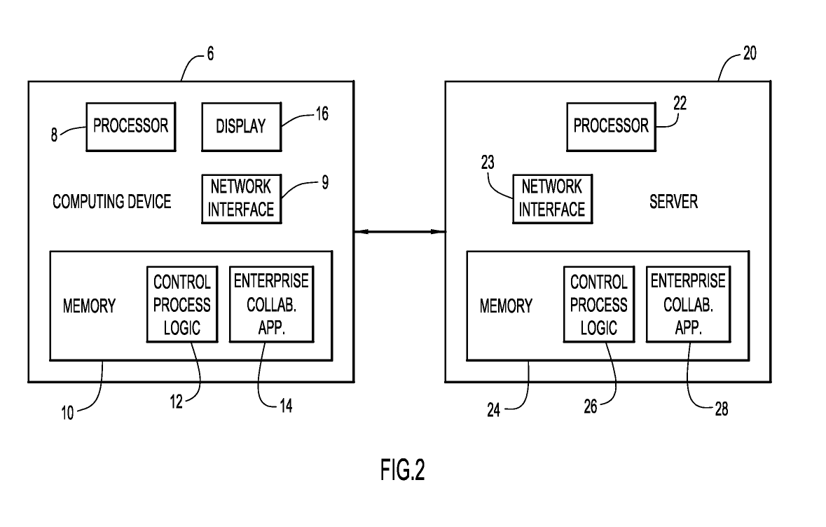

An example embodiment of an enterprise social software environment or platform supported by one or more host servers in the network 4 of the system of FIG. 1 and that facilitates the dynamic formation of trending communities is depicted in the block diagram of FIG. 2. It is noted that the example embodiment of FIG. 2 provides an enterprise collaboration platform, in which the platform facilitates an environment in which participants are provided with multiple forms or types of communication mediums to exchange information and content with other participants. However, the features described herein for dynamically forming communities based upon identified trends within the environment or platform is also applicable to other forms of social environments, including social software platforms as previously described herein.

A computing device 6 connects with a host server 20 to facilitate communications and exchange of information with other computing devices 6 associated with users of the enterprise collaboration platform. It is noted that FIG. 2 represents how each computing device 6 of the system of FIG. 1 can connect with a server 20. It is further noted that, while the embodiment of FIG. 2 depicts a single server 20, the system 2 can include multiple servers that support the enterprise collaboration platform. Each computing device 6 connects via any suitable wireless and/or hard wired connection to a server 20 to facilitate communications and exchange of information with other computing devices over the network. In particular, each computing device 6 includes a processor 8, a network interface 9, a memory 10, and a display 16. Similarly, the server 20 includes a processor 22, a network interface 23, and memory 24. The computing devices 6 and/or servers 20 can further include any other suitable devices integrated with the devices and/or any other types of peripheral devices that can be connected with the devices to facilitate input of audio, video or other information by a user to the computing device (e.g., keyboards, mouse devices, cameras, microphones, etc.) as well as output or display of audio, video and/or other types of information to the user by the computing device.

The network interfaces 9 and 23 of the computing devices 6 and servers 20 can be, for example, one or more of an Ethernet interface card or switch, a modem, a router or any other suitable hardware device that facilitates a wireless and/or hardwire connection over the network 4 with one or more servers 20 and other computing devices 6, where the network interface unit can be integrated within the device or a peripheral that connects with the device.

Each of the processors 8, 22 can comprise a microprocessor that executes control process logic instructions 12, 26 stored within memory 10, 24, including operational instructions and software applications stored within such memory (e.g., applications associated with different types of communications and sharing of information via the enterprise collaboration platform).

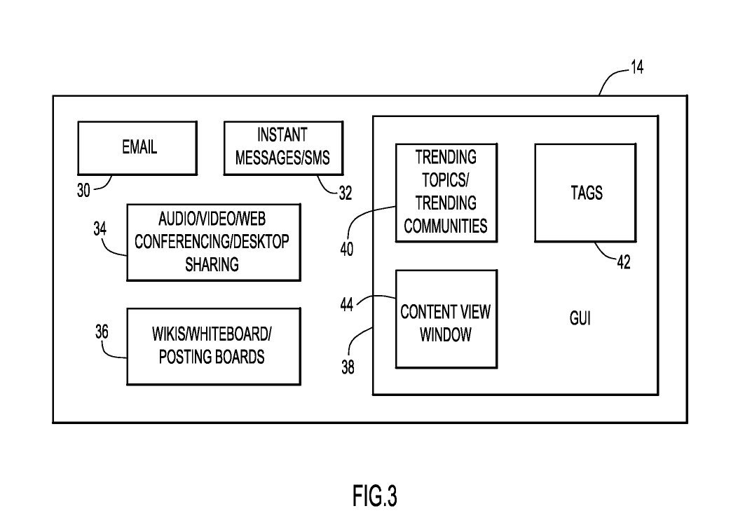

For example, the memory 10 of each computing device 6 includes an enterprise collaboration application module 14 that comprises one or more software applications, such as those depicted in FIG. 3, that provide software tools to facilitate connection of the computing device 6 to the enterprise collaboration platform, via one or more servers 20, and also engage in the various activities associated with the enterprise collaboration platform. Examples of software applications include various types of communication applications, such as one or more email messaging applications 30, which facilitate exchange of email messages as well as other email features, including calendaring and scheduling, contact lists, etc. Other examples of types of software applications of the enterprise collaboration application module include real time or near real time communication applications including, without limitation, one or more instant messaging and/or short messaging service or SMS applications 32, one or more audio, video and/or web conferencing and/or desktop sharing applications 34, one or more applications 36 to support white boarding, wikis, and posting boards for listing web blogs and/or supporting the sharing of files, documents and/or other types of content which have been posted by participants and are accessible by some or all other participants within the platform. Activities by a participant within the enterprise collaboration platform include any of the previously described features that are rendered possible by the enterprise collaboration application module 14 (e.g., communications such as email, SMS, instant messaging, etc., and the posting, viewing, modifying of blogs, documents or any other form of content within the enterprise collaboration platform).

The enterprise collaboration application module 14 of each computing device 6 further includes one or more applications that facilitate and support operation of a graphical user interface (GUI) 38 that is displayed by the computing device 6 to facilitate interaction of a participant and engagement in activities within the platform. The one or more GUI applications 38 include features which process and display within a GUI features associated with a participant's profile such as tags of the participant, as shown in window 42, a listing 40 of trending topics and trending communities with which the participant is associated, and a content view window 44 that provides content in the form of listing of emails, blogs, posted files or documents, notifications and/or any other forms of information that are associated with or relevant to the participant.

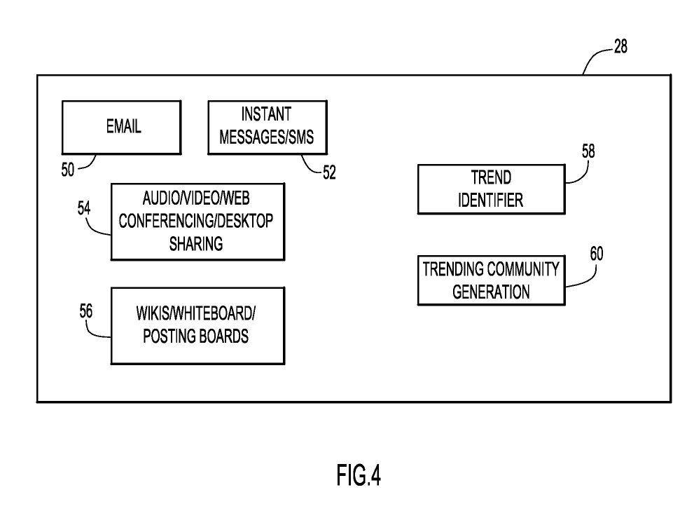

Similarly, the memory 24 of each server 20 includes an enterprise collaboration application module 28. As depicted in FIG. 4, the enterprise collaboration application module 28 comprises one or more software applications that provide software tools to facilitate hosting by the server of the various activities and sharing of information associated with the enterprise collaboration platform. For example, the module 28 can include one or more email messaging applications 50 which host email communications between participants within the platform as well as optionally hosting other features associated with such email services (e.g., hosting control of the calendaring, scheduling and contact lists), one or more applications 52 for supporting features associated with instant messaging and/or short messaging service or SMS services between participants within the platform, one or more applications 54 for supporting features associated with audio, video and/or web conferencing and/or desktop sharing applications between participants within the platform, and also one or more applications 56 to support white boarding, wikis, and posting boards for listing web blogs and/or supporting the sharing of content between participants within the platform. The enterprise collaboration platform module 28 further includes one or more applications 58 that identify trends within the platform, including trending topics (e.g., topics identified as having a sufficient frequency of interest to a sufficient number of participants over a given time period), as well as one or more applications 60 that automatically and dynamically generate trending communities and associate selected participants for joining such trending communities as well as monitor trending communities that have been generated to determine the level of activity associated with such trending communities over time. Information about identified trending topics are provided to participants, e.g., within the window 40 of the GUI 38 for each participant.

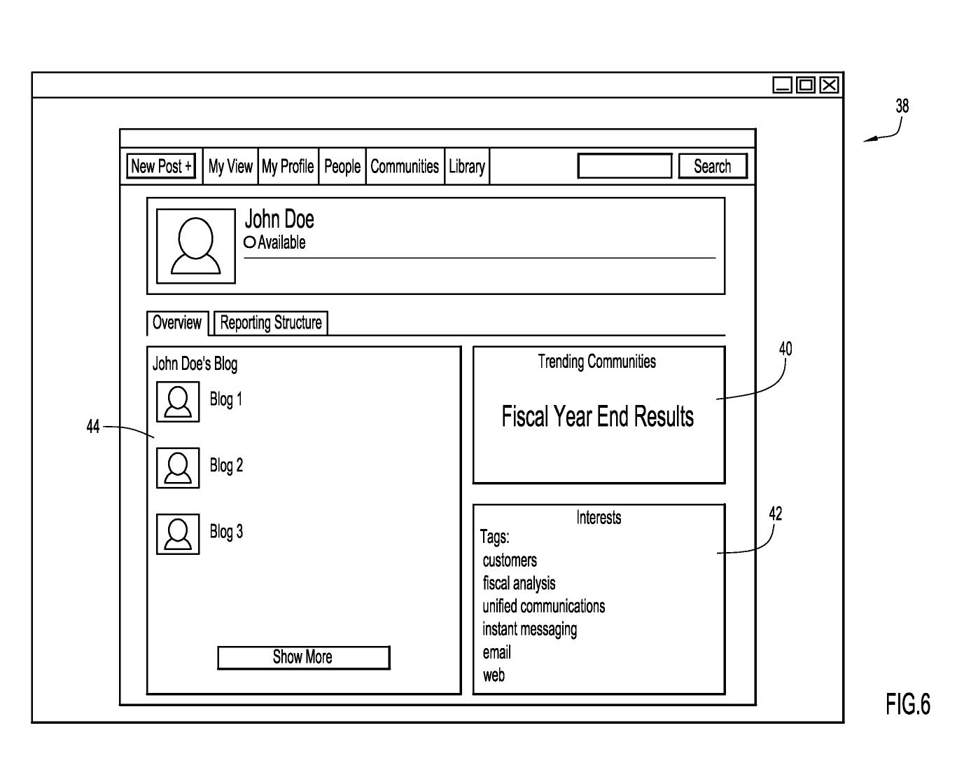

The processors 8 and 22 of the computing devices 6 and servers 20 perform operations in accordance with the steps set forth in the flow chart of FIG. 6 utilizing the software application tools of the enterprise collaboration application modules 14, 28, as described further below.

The memories 10, 24 of the computing devices 6 and servers 20 may comprise read only memory (ROM), random access memory (RAM), magnetic disk storage media devices, optical storage media devices, flash memory devices, electrical, optical, or other physical/tangible memory storage devices, and any combinations thereof. The display 16 of each computing device can be an LCD or any other suitable type of display, including touch pad displays (e.g., for tablets, smart phones, or other portable types of computing devices) for display of textual and/or graphical content by the processor 8 of the computing device 6, including audio, video, textual, interactive and/or any other forms of content which may be operated and controlled by a participant via the one or more GUI applications 38.

Some examples of computing devices 6 that can be used to engage and participate in an enterprise collaboration platform in system 2 include, without limitation, stationary (e.g., desktop) computers, personal mobile computer devices such as laptops, note pads, tablets, personal data assistant (PDA) devices, and other portable media player devices, and cell phones (e.g., smartphones) including suitable input and output devices as described above. The computing devices and servers can utilize any suitable operating systems (e.g., Android, Windows, Mac OS, Symbian OS, RIM Blackberry OS, Linux, etc.) to facilitate interaction, activities and sharing of information between computing devices via the enterprise collaboration platform.

Suitable servers 20 can be any suitable types of stationary or other types of computing devices capable of hosting and managing multiple collaboration sessions of varying types simultaneously as well as large flows of data associated with the enterprise collaboration platform. Each server 20 can be configured to provide the function of handling and transferring communication messages (e.g., email messages, audio and/or video conferencing content, instant or SMS messaging, etc.) between two or more computing devices 6 over the network 4 utilizing the modules 28 of the servers 20. Each server 20 can also be provided with suitable memory capacity to store content associated with client communications for each customer device 6 (e.g., saved email messages, instant messaging or SMS communications, and/or audio/video communications, as well as other content (e.g., blogs, wikis, white boarding content and/or other types of activities, the sharing of documents, files or other content, e.g., content that is posted and available for access by users of groups or communities within the enterprise collaboration platform). In addition, the enterprise collaboration application modules 28 of each server 20 can have suitable software tools that facilitate the hosting of synchronous communications between the computing devices 6 as well as multiple simultaneous group communications (e.g., the simultaneous hosting of a web conference between a first group of computing devices and an instant messaging communication session between a second group of computing devices).

Thus, the configurations of computing devices 6 and servers 20 as described herein facilitate engagement and interactive participation in a variety of different activities and types of communications as well as different types of communication forums (including trending communities as described herein) within an enterprise collaboration platform.

In an example embodiment, a participant at a computing device 6 includes an account that is registered with and thus recognized by the collaboration platform, and this allows the user to engage in activities such as communications (e.g., email, audio or video communications, instant messaging, etc.) as well as post, view, modify or edit information (e.g., in a blog or other written communication) and also send content to other participants within groups or communities with which the participant is associated or is a member within the enterprise collaboration platform.

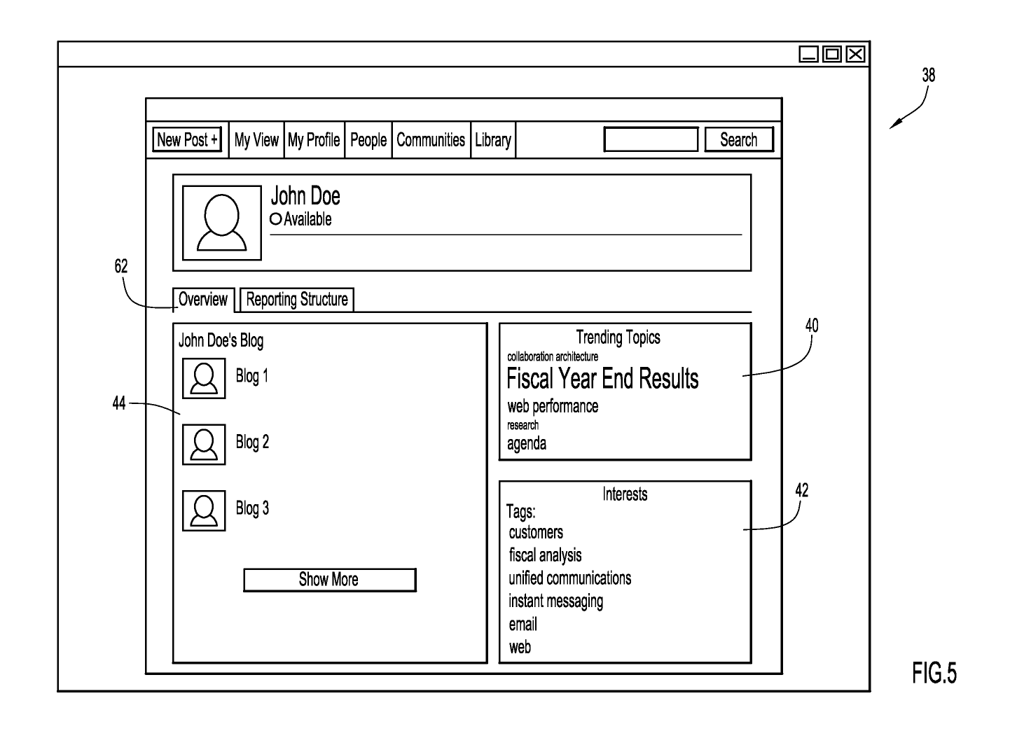

The account of the participant typically includes a graphical user interface (GUI) 38, such as the type depicted in the example embodiment of FIG. 5, that provides information about the profile of a participant (John Doe) on one or more display windows, screens or pages of the collaboration platform and which are navigable via the GUI 38. Referring to FIGS. 5 and 6, the GUI 38 includes a window 40 that can show trending topics as well as trending communities to which the participant belongs. Another window 42 provides a listing of the participant's interests, including tags associated with the participant. The tags comprise keywords or phrases that are of interest to the participant, e.g., in relation to topics, blogs, websites, persons and/or other participants, social/personal/business relationships and/or any other types of interests of the participant.

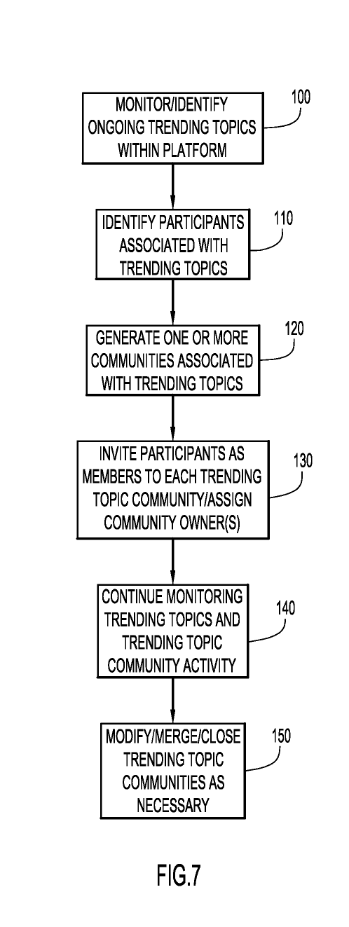

The trending topics presented in window 40 of FIG. 5 can be displayed in the form of a cloud as shown in the GUI 38, where the trending topics associated with keywords or phrases are weighted to show that some are of greater importance or priority than others (where the weighting can be displayed by increasing font size, capitalizing letters, bolding, italicizing, underlining, etc. of certain keywords or phrases having higher priority or significance to the user in relation to other keywords or phrases in the cloud). The tags in the window 42 are also weighted based upon the level of interest of the keywords or phrases to the participant. The weighting of the tags can be achieved via any known or other suitable algorithms that determine the importance of the tags to the participant at any given time. Factors such as frequency of occurrence of the keyword or phrase within content that has been generated, viewed, posted, edited or commented on, etc. by the participant or is associated with the participant in any other suitable manner, relationship of keyword or phrase to other known features of the participant's profile (e.g., known and identified interests of the participant, work related description of the participant, relationship or similarity of keyword or phrase to websites, blogs, postings or any other known forms of content with which the participant visits with a sufficient frequency, etc.) as well as any other suitable criteria are utilized by the algorithms in providing an appropriate weighting to the tags based upon the participant's known profile. The weighting of identified trending topics for presentation in the cloud shown in window 40 of FIG. 5 is described herein in relation to FIG. 7.

The GUI 38 also includes a window for viewing content 44 that is of interest or relevance to the participant. As depicted in FIG. 5, an overview listing of articles, blogs, postings or other content is depicted in the content window 44, and this listing provides links (e.g., hyperlinks) to the content when the participant selects the listing (e.g., by clicking with an interactive navigable pointer or other icon within the GUI 38 upon a selected listing). The content window 44 further includes a series of display tabs 62 (e.g., an “OVERVIEW” tab) which can be selected to show particular types of content to be viewed and/or accessed by the participant. The GUI 38 also includes other tabs or navigable features that allow the participant to navigate to different windows so as to access different types of content or engage in different forms of communication with other participants within the platform.

Operation of the system 2 of FIGS. 1-4 is now described with reference to the flow chart of FIG. 7. Throughout any given period of time, any number of computing devices 6 can be logged into the enterprise collaboration platform system 2 with varying types of content between participants being exchanged. Each participant's account profile is continuously and dynamically updated, e.g., to change the weighting of tags as well as listings of content based upon the participant's activities as well as exchange of information with other participants within the platform. In addition, at 100, one or more servers 20 continuously monitor ongoing trends (utilizing one or more trending identifier software applications 58) within the platform based upon participant relationships, interests and activities. The ongoing trends can include, e.g., trending topics having an established or defined “popularity” at any given time based upon the frequency with which a topic is deemed of interest to a sufficient number of participants.

A topic can be identified as being of sufficient interest to be considered a trending topic within the platform based upon a number of criteria including, without limitation, examination of participant tags within the platform (where the weighted value of the tag indicates the level of interest to the participant at a given time period) and frequency of activity associated with a particular topic by a sufficient number of participants within the platform over a given time period. In an example scenario, a particular tag such as the phrase “fiscal year end results” that is associated with a participant may be determined to be of great interest at a certain period of time (e.g., at the end of a company's fiscal year). However, during other time periods (e.g., at the beginning of a fiscal year for a company), the tag may not be of significant interest to the participant and thus its weighting may change based upon the criteria utilized to assign the weighting or weighted value to the tag associated with the topic (e.g., based upon a decreased frequency of activity by the participant in relation to the tag word or phrase). Thus, the weighting of a tag for a participant can change dynamically during different time periods.

Similarly, trending topics can also be automatically weighted by the server(s) 20 utilizing one or more algorithms that are based upon an identified and quantified rising or falling level of interest by participants, where the trending topics can also be assigned a weighting or weighted value that may dynamically change over any given time period. In the example scenario of the topic “fiscal year end results”, a large number of participants may express interest in this topic (thus increasing the weight value of the tag for each of these participants) at a given time period (e.g., at the end or last quarter of the fiscal year for a company). Based upon an identified number of participants showing an increased level of interest in this topic, the server(s) 20 may designate this topic as a trending topic and provide it with a weighted value that is a function of the number of participants having tags for this topic with threshold weighted values. If interest for the topic within the platform decreases over a given time period (e.g., participant tags associated with “fiscal year end results” have weighted values that decline as the fiscal year end passes into a new fiscal year), the weighted value for the trending topic will also dynamically decrease and may even drop below a threshold value in which the topic is no longer considered a trending topic.

Optionally, trending topics may also be weighted differently for different participants, based upon the level of interest to each participant of a particular topic (as determined, e.g., by the tags and/or other interests associated with the participant). Thus, a topic may be identified as a trending topic for one participant while it may not be identified as such for another participant. The server(s) 20, utilizing the one or more trending identification software applications 58, can identify potential trending topic candidates for participants by monitoring the tags associated with some or all of the participants within the platform. Alternatively, or in addition to monitoring tags, the server(s) 20 can utilize a social graph (formed utilizing any known or other suitable algorithm in association with social software environments) that identifies relationships between participants and/or content associated with participants within the platform.

As previously noted, any suitable one or more algorithms may be utilized for assigning a topic the designation as a potential trending topic. For example, topics that are identified within the platform may be assigned weighted values based at least in part upon the weighted values of participant tags that are the same or similar in content as the topics, analysis of one or more social graphs associated with the platform and/or any other criteria considered to be relevant to determining popularity or significance of a particular topic within the platform. The determination regarding whether a topic can be considered a trending topic can be based upon the assigned weighted value of the trending topic exceeding a minimum threshold value. In an optional embodiment, the server(s) 20 can also filter trending topics based upon subject matter that is not deemed suitable or appropriate for establishing a community based upon such topics.

The listing of identified trending topics, along with the weighting of such identified trending topics, can be presented to participants. Referring to FIG. 5, certain trending topics are presented in the window 42 of the GUI 38 for the participant (John Doe) having different weighted values (as indicated by the larger font size and/or bolder color of the word or phrase). For example, the trending topic “FISCAL YEAR END RESULTS” is displayed within the window 42 with a weighting that is greater than other trending topics (indicating that this trending topic is of considerable popularity or significance within the platform at the current time). As previously noted, the weighted value of this trending topic may decrease at some future time period (e.g., after the fiscal year has passed and the year end results are no longer of elevated significance), and such reduced weighting would then result in the trending topic no longer being prominently displayed within window 42 (i.e., a reduced weighting would reduce the font size and/or bold color of the displayed topic). If the weighted value of the trending topic falls below the minimum threshold value to be considered a trending topic, it may be removed from the listing of trending topics altogether. Thus, the continuous monitoring and identification of trending topics occurs dynamically over time within the platform, with trending topics changing weighted values based upon their identified and quantified change in popularity or significance as determined by changing participant interests within the platform, and with some trending topics dropping below a threshold weighted value and thus dropping from the list while new trending topics may be added to the list based upon changing interests of the participants.

At 110, certain participants of the platform are identified as being sufficiently associated with one or more trending topics based upon their activities, interests (e.g., tags or other interests noted in each participant's profile) and any other suitable criteria. For example, a participant may be considered sufficiently associated with a trending topic based upon how many posts, blogs, comments or other activities the participant has engaged in over a specified time period in relation to the trending topic. The participant's tags, which are also weighted based upon similar criteria, can also be used to identify whether a participant is sufficiently associated with a trending topic. For example, for the trending topic “FISCAL YEAR END RESULTS”, if a participant has one or more tags that include words or phrases that are the same or similar to this trending topic and these tags have significant weight values for the participant (e.g., the tags are weighted in the upper majority of all tags for the participant), this participant can be considered sufficiently associated with the trending topic.

Upon identifying a group of participants that are sufficiently associated with a trending topic, the server(s) 20 (via one or more trending community generation applications 60) automatically generate a trending topic community for each identified group of participants.

As previously noted, communities are known within enterprise social software platforms, including collaboration platforms such as the type described in the example embodiment depicted in the figures. A community comprises a collection or group of participants within the platform who join together based upon one or more common interests or goals. The community can be exclusive (e.g., only allowing access to existing members and being selective upon which new members to invite or accept into the community), thus limiting access to content and interactive engagement within the community to accepted members. While enterprise social software platforms enable one or more participants to manually create or generate a community, this can be time consuming and may not result in the best or most ideal combination of participants to engage and enrich the community. In contrast, in accordance with the systems and methods described herein, the server(s) 20 of the system 2 automatically and dynamically generate communities based upon identified trending topics having been established as meeting a threshold level of significance within the platform and automatically identify the most suitable participants to be associated with such trending topic communities.

The server(s) 20 can further utilize additional criteria to determine whether to generate a trending topic community. Some examples of additional criteria include, without limitation, the number of participants identified to be sufficiently associated with a trending topic (e.g., if there is less than a minimum threshold number of identified participants, no trending topic community is generated), and the similarity of the trending topic with an already existing trending topic community. For example, if the trending topic is considered to be of sufficient similarity to an already existing trending topic community, the server(s) 20 may associate the identified participants with the already existing trending topic community or generate a sub-community linked with the already existing community and associate the identified participants with the sub-community.

An ontology can be utilized to link trending topics with one or more existing communities within the enterprise social software platform. One accepted standard ontology that could be used without limitation is SIOC (semantically interlinked online community, http://sioc-project.org/ontology). As defined, the SIOC ontology can be used to model a community. Furthermore, SIOC can be extended using W3C standards such as OWL (Web Ontology Language, http://www.w3.org/2004/OWL/) to cater to community relationships. With such an extension SIOC can be used in this context to both model a community and relate a community to other communities. As SIOC by default caters to relationships between communities, participants and content it can be used to model these relationships also.

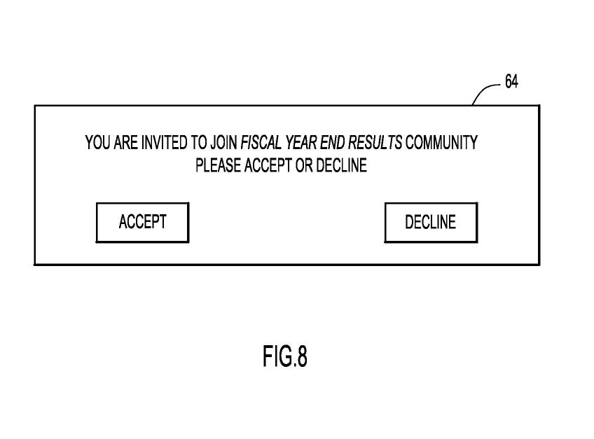

At 130, participants that have been identified as being sufficiently associated with a trending topic and corresponding trending topic community (e.g. a newly generated trending topic community) are automatically invited by the server(s) 20 (via the one or more trending community generation applications 60) to join the trending topic community. The invitation can be generated, e.g., as a pop-up message or window that appears in the display 16 of the computing device 6 (e.g., in association with the GUI 38) for the participant. An example embodiment of a pop-up window invitation 64 provided to a participant (e.g., John Doe) within the system 2 to join a particular trending topic community (e.g., FISCAL YEAR END RESULTS) is depicted in FIG. 8.

At 130, the server(s) 20 further determine which of the participants identified with the trending topic community might be considered owners within the community. An owner within a community can be provided with special or enhanced privileges that not every member has within the community. For example, a designated owner may control content that is circulated within the community, may control membership within the community (e.g., admittance or expulsion of members to the community), may control access to the community as well as perform any suitable types of administrative functions associated with the community. The determination regarding which potential invitees to the trending topic community may be considered owners can be based upon any suitable criteria that establish an elevated level of association or identification of a participant in relation to other participants with respect to the trending topic. For example, an invited participant may be designated as a potential owner if the participant was an originator of the trending topic (e.g., the participant posted the first comment or blog that developed or evolved into a trending topic within the platform), the participant has the greatest or one of the greatest frequencies of contribution to the trending topic (e.g., most postings of comments, blogs, articles and/or any other content in relation to the trending topic and/or most following participants or most identified participants having viewed of any content posted by the participant), etc.

When a participant accepts membership to a trending topic community to which the participant has been invited, the trending topic community is listed within the trending topic community window 40 of the GUI 38 for the participant as shown in FIG. 6. For example, the participant (John Doe) has accepted membership to the FISCAL YEAR END RESULTS community, and the participant can display this community as well as other trending topic communities to which the participant belongs within the window 40 of the GUI 38. The participant can engage within this or any other community based upon the rules associated with the community for the participant. For example, the participant may enter a community by selecting it (e.g., by clicking on the community via an interactive pointer or other movable icon of the GUI 38) within the window 40.

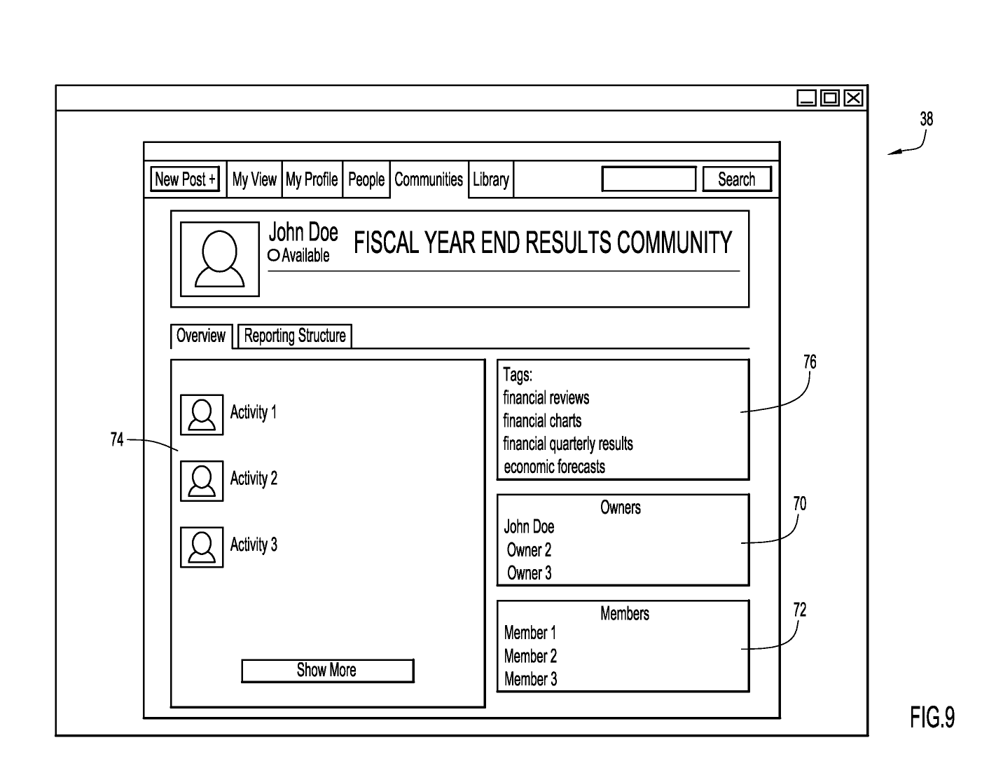

An example embodiment of a trending topic community environment within which the participant (John Doe) can engage according to the techniques described herein is depicted in the GUI image 38 of FIG. 9. Referring again to FIG. 6, the participant can select a trending topic community from window 40 (e.g., FISCAL YEAR END RESULTS). By selecting the trending topic community (e.g., by clicking on the appropriate community with a mouse pointer or selecting the community via any other suitable input device), the participant can navigate, via the GUI 38, to that trending topic community, such as the community depicted in FIG. 9. The owners of the community (including John Doe), who can be determined based upon the techniques described herein, are listed in window 70. Members of the community are listed in window 72. A listing of activities (e.g., links to messages, blogs, posted documents or other content, etc.) associated with the trending topic community (e.g., activities associated with FISCAL YEAR END RESULTS) are provided in window 74 of the GUI 38. A listing of tags or a tag cloud is provided in window 76. The tags are topics and/or communities that are related to the trending topic and which may have an influence on the formation of the trending topic community (e.g., tags such as financial reviews, financial charts, financial quarterly results, economic forecast, etc., as shown in window 76, are related to FISCAL YEAR END RESULTS).

At 140, the server(s) 20 continue to monitor trending topics in the same manner as previously described with relation to step 100. As previously noted, the weighted values of trending topics can increase (e.g. spike) and then decrease or subside over select time periods. The change in weighting of the trending topics can also affect the activity within corresponding trending topic communities, and activities within the trending topic communities are also monitored by the server(s) 20 (e.g., monitoring frequency of entrance/exit of participants within the community, frequency of postings or exchange of content within the community, etc. over a given time period). For example, if a trending topic such as FISCAL YEAR END RESULTS decreases significantly in weighted value due to the time period passing beyond a particular year end and entering a new year, activities by members within the corresponding trending value community can also decrease to a point in which there is little or no activity within the community at this time period.

The server(s) 20 monitor community activity and, at 150, take any action that may be deemed necessary to maintain optimum and efficient performance of the platform. In particular, the server(s) 20 may suggest (e.g., to one or more owners or members of the community) that the community be closed, suspended or terminated due to lack of activity over a specified period of time. A suspension of the trending topic community may be utilized in scenarios in which the weighted value of the trending topic spikes and then decreases in a cyclical manner over a time period (which is a likely scenario for a topic such as the FISCAL YEAR END RESULTS trending topic). Alternatively, the server(s) 20 may suggest modification to the community (e.g., moving the storage location of the community to an offsite or a less expensive storage location) for as long as the community maintains a low activity status (e.g., the community has less than a minimum threshold of ongoing activities within the community over a specified time period).

The server(s) 20 can also identify similar communities that also exist within the platform and merge the trending topic community with a community that is considered most similar (e.g., based upon a determination of a sufficiently similar relationship between topics associated with each community) so as to optimize operations and avoid unnecessarily large numbers of communities being generated. Some criteria for determining whether to merge a trending topic community with another community include, without limitation, identified similarity in content (e.g., based upon identified keywords or phrases associated with such content) and/or participants associated with each community The merging of two communities can occur after generation and assigning membership to a trending topic community. Alternatively, a trending topic that has been identified and determined as being of sufficient significance within the platform may be compared with existing communities to determine whether it would be preferable to invite participants sufficiently associated with the trending topic to join an existing community that is determined to have a suitable or sufficient degree of similarity with the trending topic rather than generate a new community for the trending topic. Further still, a trending topic community can be merged as a sub-community within an existing community in scenarios in which the trending topic is related in content to the existing community but may also be considered to have sufficient differences to warrant a sub-categorization of the trending topic community within the existing community.

Thus, the systems and corresponding methods described herein provide a dynamic generation of communities within an enterprise social software platform based upon trending topics, where the peaking or declining of such trending topics in popularity or significance influences the lifespan, operation and/or system maintenance and support of the corresponding trending topic communities within the platform.

The establishment of weighted value thresholds for determining whether certain topics within the platform become trending topics and also whether such trending topics achieve a threshold for automatic generation of trending topic communities allows a system administrator or other operator to selectively adjust such weighted value thresholds as desired. For example, if the threshold weighted values are set too low for establishing trending topics and corresponding generation of trending topic communities, a potential resulting effect may be the generation of a large number or overwhelming volume of trending topic communities. The system administrator can adjust the sensitivity of the system to identifying trending topics with relative ease by adjusting or tuning the threshold weighted values (e.g., increasing one or more criteria threshold values for identifying a trending topic to a new level) so as to reduce the number or amount of trending topics that result in automatic generation of corresponding trending topic communities. In an example embodiment, the system administrator can adjust the criteria for identifying a trending topic and/or generating a corresponding community for the trending topic if there is a sufficiently large number of activities (e.g., a sufficient number of responses, comments, etc. to a blog or other content posting) associated with a topic from a sufficient number of participants (e.g., need at least a threshold number of different participants engaging in activities associated with the topic).

The above description is intended by way of example only.

What is claimed is:

1. A method comprising:
automatically identifying a trending topic within a social software enterprise platform, the trending topic comprising a topic that includes content relating to a threshold amount of activities associated with participants of the platform;
automatically generating a trending topic community within the platform in response to the trending topic meeting a threshold criteria; and
automatically inviting participants identified as being associated with the trending topic to join as members of the trending topic community.

2. The method of claim 1, further comprising:
adjusting the threshold criteria that determines whether a trending topic results in generating a trending topic community.

3. The method of claim 1, further comprising:
automatically inviting one or more participants identified as being associated with the trending topic to join the trending topic community as an owner, wherein an owner of the trending topic community controls features of the community that cannot be controlled by a member of the community.

4. The method of claim 3, further comprising:
defining a participant as a potential owner based upon a threshold level of activity the participant has engaged in the platform in relation to the trending topic.

5. The method of claim 1, further comprising:
generating a listing of trending topics for a participant within a graphical user interface associated with the participant, wherein the graphical user interface provides participant interactivity within the platform.

6. The method of claim 1, further comprising:
generating a listing of trending topic communities for a participant within a graphical user interface associated with the participant, wherein the graphical user interface provides participant interactivity within the platform and the listing comprises trending topic communities to which the participant has been invited to join.

7. The method of claim 1, further comprising:
automatically monitoring a level of activity within the trending topic community; and
in response to the monitored level of activity being below a threshold amount, automatically generating a request to one or more participants to modify, suspend or terminate the trending topic community.

8. The method of claim 1, wherein the enterprise social software platform comprises an enterprise collaboration platform that facilitates exchange of content between participants via a plurality of different types of communications.

9. An apparatus comprising:
a memory configured to store instructions including one or more enterprise social software applications; and
a processor configured to execute and control operations of the one or more enterprise social software applications so as to:
identify a trending topic within a social software enterprise platform, the trending topic comprising a topic that includes content relating to a threshold amount of activities associated with participants of the platform;
generate a trending topic community within the platform in response to the trending topic meeting a threshold criteria; and
invite participants identified as being associated with the trending topic to join as members of the trending topic community.

10. The apparatus of claim 9, wherein the processor is further configured to execute and control operations of the one or more enterprise social software applications so as to:
adjust the threshold criteria that determines whether a trending topic results in generating a trending topic community.

11. The apparatus of claim 9, wherein the processor is further configured to execute and control operations of the one or more enterprise social software applications so as to:
invite one or more participants identified as being associated with the trending topic to join the trending topic community as an owner, wherein an owner of the trending topic community controls features of the community that cannot be controlled by a member of the community.

12. The apparatus of claim 11, wherein the processor is further configured to execute and control operations of the one or more enterprise social software applications so as to:
define a participant as a potential owner based upon a threshold level of activity the participant has engaged in the platform in relation to the trending topic.

13. The apparatus of claim 9, wherein the processor is further configured to execute and control operations of the one or more enterprise social software applications so as to:
generate a listing of trending topics for a participant within a graphical user interface associated with the participant, wherein the graphical user interface provides participant interactivity within the platform.

14. The apparatus of claim 9, wherein the processor is further configured to execute and control operations of the one or more enterprise social software applications so as to:
generate a listing of trending topic communities for a participant within a graphical user interface associated with the participant, wherein the graphical user interface provides participant interactivity within the platform and the listing comprises trending topic communities to which the participant has been invited to join.

15. The apparatus of claim 9, wherein the processor is further configured to execute and control operations of the one or more enterprise social software applications so as to:
monitor a level of activity within the trending topic community; and
in response to the monitored level of activity being below a threshold amount, generate a request to one or more participants to modify, suspend or terminate the trending topic community.

16. The apparatus of claim 9, wherein the memory further comprises one or more enterprise collaboration applications, and the processor is further configured to execute and control operations of the one or more enterprise collaboration applications so as to facilitate an exchange of content between participants via a plurality of different types of communications.

17. One or more computer readable storage media encoded with software comprising computer executable instructions and when the software is executed operable to:
identify a trending topic within a social software enterprise platform, the trending topic comprising a topic that includes content relating to a threshold amount of activities associated with participants of the platform;
generate a trending topic community within the platform in response to the trending topic meeting a threshold criteria; and
invite participants identified as being associated with the trending topic to join as members of the trending topic community.

18. The computer readable storage media of claim 17, and further comprising instructions that are operable to:
adjust the threshold criteria that determines whether a trending topic results in generating a trending topic community.

19. The computer readable storage media of claim 17, and further comprising instructions that are operable to:
invite one or more participants identified as being associated with the trending topic to join the trending topic community as an owner, wherein an owner of the trending topic community controls features of the community that cannot be controlled by a member of the community.

20. The computer readable storage media of claim 19, and further comprising instructions that are operable to:
define a participant as a potential owner based upon a threshold level of activity the participant has engaged in the platform in relation to the trending topic.

21. The computer readable storage media of claim 17, and further comprising instructions that are operable to:
generate a listing of trending topics for a participant within a graphical user interface associated with the participant, wherein the graphical user interface provides participant interactivity within the platform.

22. The computer readable storage media of claim 17, and further comprising instructions that are operable to:
generate a listing of trending topic communities for a participant within a graphical user interface associated with the participant, wherein the graphical user interface provides participant interactivity within the platform and the listing comprises trending topic communities to which the participant has been invited to join.

23. The computer readable storage media of claim 17, and further comprising instructions that are operable to:
monitor a level of activity within the trending topic community; and
in response to the monitored level of activity being below a threshold amount, generate a request to one or more participants to modify, suspend or terminate the trending topic community.

24. The computer readable storage media of claim 17, and further comprising instructions that are operable to:
facilitate exchange of content between participants via a plurality of different types of communications.
